(19) United States
(12) Patent Application Publication
(10) Pub. No.: US 2008/0074643 A1
(43) Pub. Date: Mar. 27, 2008

(54) Medical devices with color characteristics and use thereof

(75) Inventors: Sinn-Wen Chen, Hsinchu (TW); Feng-Ling Chen, Hsinchu (TW); An-Ren Zi, Hsinchu (TW); Jee-Jay Chen, Hsinchu (TW)

Correspondence Address: BACON & THOMAS, PLLC, 625 SLATERS LANE, FOURTH FLOOR, ALEXANDRIA, VA, 22314, US

(73) Assignee: National Tsing Hua University, Hsinchu (TW)

(21) Appl. No.: 11/898,828

(22) Filed: Sep. 17, 2007

(30) Foreign Application Priority Data
Sep. 25, 2006 (TW) 095135446

(51) Int. Cl. G01L 9/06; A61C 7/14; A61C 7/16

(52) U.S. Cl. 356/32; 433/20; 433/8

(57) ABSTRACT

This invention takes advantages of color characteristics of medical devices for the cosmetic and indication purposes. For example, the appearances of the metallic brackets used in orthodontics are improved with colors other than the original metallic color by surface treatment using plasma techniques. For example, orthodontic brackets are made with piezochromic materials. When the archwire's torsion and bending forces are fading due to the movement of the teeth, the color of the pressure sensitive brackets will be changed, and the need of archwire's readjustment to have proper torsion and bending forces is signalized. For example, rehabilitation equipments are made with piezochromic materials. When the pressures exerting on the rehabilitation equipments are different, different colors of the equipments are displayed, and the therapists can then act accordingly.

### FIELD OF THE INVENTION

The present invention relates to medical devices with color characteristics for the cosmetic and indication purposes.

### BACKGROUND OF THE INVENTION

Orthodontics has become a popular dental treatment where an orthodontic archwire is one of the main materials used in this treatment. A brackets are adhered onto teeth of a person receiving the orthodontic treatment, and an archwire is fastened to the brackets. Proper torsion and bending forces are exerted to the brackets by adjusting the shape of the archwire, and the target tooth or teeth are gradually moved due to the forces transferred from the brackets adhered to the teeth. At present, common orthodontic brackets used are made of metallic materials, such as stainless steel, or ceramic materials, such as poly alumina. One of the main reasons of using the ceramic material is for an improved appearance. The force acting on the brackets is closely related to the magnitude of the strain of the archwire, which is eventually decreasing due to the movement of the target tooth or teeth. Consequently, the person receiving the orthodontic treatment will have to return to his or her dentist regularly for re-adjusting the magnitude of the strain of the archwire. At present, the timing of return and the re-adjustment of the archwire rely on the experiences of the dentist and vary among different dentists. So far there is no orthodontic bracket made from a piezochromic material, thereby having a color indication ability when the archwire's torsion and bending forces are fading.

In addition to orthodontics, the rehabilitation treatments also require knowledge of the magnitude of the force applied to the patient. So far, there is no rehabilitation equipment is made with a piezochromic material, thereby having a color indication ability when the force exerting on the rehabilitation equipments is different.

In the above-mentioned U.S. patent application Ser. No. 11/429,107, filed May 8, 2006, now published US2006/0199139 A1, an orthodontic archwire with more than one colors is disclosed, which is prepared by subjecting the orthodontic archwire to an anodizing treatment.

### SUMMARY OF THE INVENTION

A primary objective of the present invention is to provide to a metallic medical device with a color which is different from its original metallic gloss by plasma treatment.

Another objective of the present invention is to provide to a medical device with a color indication ability when a force exerting thereon changes.

Still another objective of the present invention is to provide to a method of using a piezochromic material to determine whether a desired force is being applied to a medical device, which comprises observing whether a color of the medical device made with the piezochromic material changes.

### DETAILED DESCRIPTION OF THE PREFERRED EMBODIMENTS

Preferred embodiments of the present invention include (but not limited to) the followings:

1. A method of using a plasma treatment to make color indication of a metallic medical device comprising subjecting a metallic medical device to a plasma treatment for a period of time sufficient to convert an original metallic gloss of the metallic medical device to a color different from the original metallic gloss thereof.

2. The method of Item 1 further comprising preparing a metallic medical device and cleaning a surface of the metallic medical device prior to the plasma treatment.

3. The method of Item 1, wherein the plasma treatment is conducted in an atmosphere comprising oxygen as a working gas.

4. The method of Item 3, wherein the plasma treatment is conducted under conditions of a pressure of about 10⁻³ torr, a temperature of about 300° C. and a voltage of about 50 KV for a period of about 120 minutes.

5. The method of Item 1, wherein the metallic medical device is an orthodontic archwire or bracket.

6. The method of Item 5, wherein the metallic medical device is made of an alloy comprising β-titanium as a major element.

7. The method of Item 6, wherein the alloy further comprises nickel.

8. The method of Item 7, wherein the color is blue.

9. The method of Item 2, wherein the cleaning is conducted by subjecting the metallic medical device to an plasma treatment taking place in an atmosphere of inert gas.

10. The method of Item 9, wherein the cleaning further comprises immersing the metallic medical device in an acidic aqueous solution prior to the plasma treatment taking place in an atmosphere of inert gas.

11. The method of Item 10, wherein the acidic aqueous solution is an aqueous of hydrogen chloride.

12. A method of using a piezochromic material to determine whether a desired force is being applied to a medical device, which comprises constructing a medical device with a part thereof is made of a piezochromic material; and observing a color of said part, wherein the color of said part changes as a force exerted thereon changes.

13. The method of Item 12, wherein the medical device is an orthodontic archwire or bracket.

14. The method of Item 13, wherein the medical device is an orthodontic bracket.

15. The method of Item 12, wherein the medical device is a rehabilitation device.

16. The method of Item 14, wherein the piezochromic material is mono-crystalline CuMoO₄ or poly(5,8-dihexadecyloxyanthraquinone-1,4-diyl).

17. The method of Item 15, wherein the piezochromic material is mono-crystalline CuMoO₄ or poly(5,8-dihexadecyloxyanthraquinone-1,4-diyl).

The biocompatibility of an orthodontic archwire and bracket is very important because such an orthodontic archwire and bracket are mounted on the teeth of a person. Therefore, an ordinary dying or pigment coating technique cannot be applied on the coloring of an orthodontic archwire and bracket. The coloring method of plasma treatment according to the present invention uses the optical interference effect of the oxide film on the surface of the material without external addition of a pigment. The products resulting from the plasma treatment are oxides of the metallic elements of the orthodontic archwire, which are formed on the surface of the orthodontic archwire and bracket. For an ordinary metal element, its oxide is often more stable than the metal element, that is the biocompatibility after plasma treatment will become better. Therefore, the plasma treatment will not introduce an additional biocompatibility problem. Furthermore, the plasma treatment according to the present invention only oxidizes the surface of the material such that the mechanical strength of the orthodontic archwire and bracket will not be affected conspicuously. In other words, a plasma treatment can alter the outlook color of an orthodontic archwire and bracket, without significantly changing the biocompatibility and mechanical strength thereof (wherein the former might be increased slightly, while the later might be decreased or increased slightly). The plasma treatment is also applicable to dental crowns for altering the outlook color without significantly changing the biocompatibility and mechanical strength thereof.

Colors are obvious and ideal for showing the properties of a material. For certain medical treatments, such as orthodontics and rehabilitation, the magnitude of a force applied is an important factor in the medical treatments. Among various properties of a material there is a property called piezochromic, that is the outlook color of a material changes when the force exerted thereon changes. Up to now the piezochromic material has not been utilized in the fabrication of a medical device having a color indication ability when the force exerted thereon changes. The present invention first discloses the utilization of a piezochromic material in the fabrication of a medical device having a color indication ability when the force exerted thereon changes, such as an orthodontic bracket and rehabilitation equipment, among others. It is apparent that the color of the pressure sensitive brackets of the present invention will be changed, when the archwire's torsion and bending forces are fading due to the movement of the teeth, and thus the need of archwire's readjustment to have proper torsion and bending forces can be signalized. Similarly, when the pressures exerting on the rehabilitation equipments are different, different colors of the equipments are displayed, and the therapists can then act accordingly.

### Example 1

A substrate of NiTi alloy was subjected to a heat treatment at 400° C. for 70 minutes, and quenched, followed by surface etching and polishing. The polished NiTi substrate was placed in a plasma chamber, and surface cleaning was then carried out under the following conditions:

Pressure: 100 Pa

Temperature: 100-300° C.

Ar flow rate: 100 cc/min

Voltage: 5 KV

Time: 1 hour.

A plasma treatment for undergoing surface implantation of oxygen ions on the NiTi substrate was then conducted in the same plasma chamber under the following conditions:

Pressure: 10⁻³ torr

Temperature: 300° C.

Ar flow rate: 3×10¹⁷ atom/cm²

O₂ flow rate: 3×10¹⁷ atom/cm²

Voltage: 50 KV

Time: 2 hours.

The resulting NiTi substrate from the plasma treatment has an outlook color of blue.

### Example 2

Rodrigues et al. report a piezochromic material of mono-crystalline CuMoO₄ (Rodrigues, Hernandez, Garcia-Jaca, Ehrenberg and Weitzel, Physical Review B, 2000, Vol. 61, No. 24, pp. 16497-16501). A substrate is made of this piezochromic material of CuMoO₄, which is brick red at a pressure of 2.5 kbar, and it turns to green when the pressure is released. A medical device built with this substrate as a stress part will have an ability of indicating the change of stress exerted on the substrate by observing the color change thereof.

### Example 3

Muramatsu et al. report a piezochromic material of poly(5,8-dihexadecylo-xyanthraquinone-1,4-diyl (Muramatsu, Yamamoto, Hasegawa, Yagi, and Koinuma, Polymer, 2001, Vol. 42, pp. 6673-6675). A substrate is made of this piezochromic material of poly(5,8-dihexadecylo-xyanthraquinone-1,4-diyl, which is yellow at atmospheric pressure and at room temperature, and it turns to dark red when the pressure is increased to 11 kbar. A medical device built with this substrate as a stress part will have an ability of indicating the change of stress exerted on the substrate by observing the color change thereof.

1. A method of using a piezochromic material to determine whether a desired force is being applied to a medical device, which comprises constructing a medical device with a part thereof is made of a piezochromic material; and observing a color of said part, wherein the color of said part changes as a force exerted thereon changes.

2. The method of claim 1, wherein the medical device is an orthodontic archwire or bracket.

3. The method of claim 2, wherein the medical device is an orthodontic bracket.

4. The method of claim 1, wherein the medical device is a rehabilitation device.

5. The method of claim 3, wherein the piezochromic material is mono-crystalline CuMoO₄ or poly(5,8-dihexadecyloxyanthraquinone-1,4-diyl).

6. The method of claim 4, wherein the piezochromic material is mono-crystalline CuMoO₄ or poly(5,8-dihexadecyloxyanthraquinone-1,4-diyl).
